(19) United States
(12) Patent Application Publication
(10) Pub. No.: US 2014/0239026 A1
(43) Pub. Date: Aug. 28, 2014

(54) VEHICLE RECEIVER HITCH SUPPORTED LOCKABLE SPORTING EQUIPMENT CARRIER

(71) Applicant: Neil D. Johnson, Spokane, WA (US)

(72) Inventor: Neil D. Johnson, Spokane, WA (US)

(21) Appl. No.: 14/187,630

(22) Filed: Feb. 24, 2014

Related U.S. Application Data
(60) Provisional application No. 61/851,001, filed on Feb. 28, 2013.

(51) Int. Cl. B60R 9/06

(52) U.S. Cl. CPC B60R 9/06
USPC 224/519

(57) ABSTRACT

A vehicle receiver hitch supported lockable sporting equipment carrier provides a receiver hitch beam carrying an upwardly extending vertical beam. A load beam is structurally carried by the vertical beam, at an end portion opposite the receiver hitch beam. The load beam is fluted on an outer circumferential surface and defines an axial channel extending therethrough for releasable engagement with a locking bar. The locking bar has one leg that releasably engages with the load beam, and a second leg that releasably engages with the vertical beam. An equipment support having a base tray and a load beam sleeve defining mating flute notches and ridges releasably adjustably engages with the load beam to prevent axial rotation of the equipment support relative to the load beam.

### RELATED APPLICATIONS

This application claims the benefit of earlier filed U.S. Provisional Patent Application No. 61/851,001 filed on Feb. 28, 2013 and titled Vehicle Hitch Mounted Sporting Equipment Carrier and Locking System. This application is also related to, and is an improvement upon U.S. Pat. No. 8,622,267 issued Jan. 7, 2014. Inventorship and ownership of earlier filed U.S. Provisional Patent Application No. 61/851,001, the instant Utility Patent application and U.S. Pat. No. 8,622,267 are the same, all Neil D. Johnson. The entire teachings of 61/851,001 and U.S. Pat. No. 8,622,267 are both incorporated herein, in their entirety, by this reference.

### FIELD OF INVENTION

The present invention relates generally to sporting equipment racks used for carrying items, such as bicycles, on a vehicle. More particularly, the invention relates to a vehicle receiver hitch supported sporting equipment carrier having an integrated locking system to prevent theft of the sporting equipment carried on the carrier.

### BACKGROUND AND DESCRIPTION OF PRIOR ART

Bicycling has become a popular activity and enthusiasts engaging in the sport range from professionals who make their livelihoods racing and riding bicycles, to recreational riders and children who simply enjoy the freedom bicycles provide. As would be expected, as the popularity of bicycling has increased, advancements in technology and equipment have followed, and consequently bicycles may have substantial values ranging into the thousands of dollars for professional racing type bicycles.

Unfortunately, as the value of such bicycles has increased, so has the likelihood of theft of such bicycles, which can lead to significant economic loss, insurance claims, damage to professional livelihoods, and even emotional trauma.

Vehicle mounted bicycle carrying racks are known, and are available, in a variety of configurations. Known bicycle carrying racks generally support bicycles in an upright position and engage with the bicycle wheels and/or frame in a variety of ways. Such racks may carry the front and/or rear wheel of the bicycle in a tray, and have an adjustable pivoting arm that also engages with the bicycle frame. Other known racks have one or more generally horizontal load bars carrying one or more open-top “saddles” that releasably engage a portion of the bicycle frame so that the bicycle is suspended therefrom. Most bicycle carrying racks further have at least one, and preferably several straps that are used to positionally secure the bicycle to the rack and/or to the open top saddles.

For bicycle racks of the type having a single, generally horizontal load bar carrying an open top saddles in which a portion of the bicycle frame is carried, another problem is the tendency of the open top saddle, carrying the bicycle, to rotate about the generally horizontal load bar due to the torque applied to the open top saddle by the weight of the bicycle carried therein/thereon. The torque may cause the saddle to rotate about the load bar allowing the carried bicycle to fall off, or slide there-along possibly to a position where a portion of the bicycle may contact the ground while the vehicle is moving resulting in possibly catastrophic damage to the bicycle as well as to the carrier and to the vehicle.

One feature that it is lacking from bicycle carrying racks having a single generally horizontal load bar carrying one or more open top saddles is a means to prevent torque initiated rotation of the open top saddle about the load bar caused by the weight of the carried bicycle.

In the past, users have attempted to secure the open top saddles or other bicycle carrying apparatus with setscrews threadably engaged with the open top saddle and frictionally engaging with the load bar to prevent torque caused rotation. Unfortunately setscrews are prone to failure, and using a wrench, or other mechanical means to securely tighten the setscrews may cause damage to the load bar and also necessitates the use of tools which may be lost or unavailable when needed. This is particularly problematic when a bicycle owner needs to adjust the position of the open top saddles to accommodate different styles, or sizes of bicycles or when spacing between the bicycles/saddles needs to be changed.

What is needed is an anti rotation apparatus that is integrated into a bicycle carrying rack that is easy to operate, is difficult for unauthorized people to remove, is easily storable, is easily operable, does not require modification of the bicycle, does not require special attachments, does not require special tools and is suitable for use with nearly any size and configuration of bicycle that might be desired to be carried upon the bicycle rack.

My invention overcomes various of the aforementioned drawbacks and resolves various of the aforementioned needs by providing an improved vehicle receiver hitch supported lockable sporting equipment carrier having an integrated locking assembly for securely and safely carrying bicycles and sporting equipment. My invention is easy to operate, and does not require modification of the bicycle, or any attachments to a bicycle frame. My invention prevents torque induced rotation of the open top saddle and the carried bicycles, is easily storable on the bicycle rack, and cannot be easily or quickly cut or broken allowing unauthorized removal or movement of bicycles carried on the rack.

My invention does not reside in any one of the identified features individually but rather in the synergistic combination of all of its structures, which give rise to the functions necessarily flowing therefrom as hereinafter specified and claimed.

Some or all of the drawbacks and problems explained above, and other drawbacks and problems, may be helped or solved by the invention shown and described herein. My invention may also be used to address other drawbacks and problems not set out herein or which become apparent at a later time. The future may also bring to light unknown benefits which may in the future be appreciated from the novel invention shown and described herein.

### SUMMARY

A vehicle receiver hitch supported lockable sporting equipment carrier provides a receiver hitch beam carrying an upwardly extending vertical beam. A load beam is structurally carried by the vertical beam, at an end portion opposite the receiver hitch beam. The load beam is fluted on an outer circumferential surface and defines an axial channel extending therethrough for releasable engagement with a locking bar. The locking bar has one leg that releasably engages with the load beam, and a second leg that releasably engages with the vertical beam. An equipment support having a base tray and a load beam sleeve defining mating flute notches and ridges releasably adjustably engages with the load beam to prevent axial rotation of the equipment support relative to the load beam.

In providing such vehicle receiver hitch supported lockable sporting equipment carrier it is:

a principal object is to provide a bicycle carrying rack having equipment supports that cannot unintentionally rotate relative to a support beam.

a further object to provide such a carrier having equipment supports that are securely angularly positionable relative to the load beam.

a further object to provide such a carrier that is releasably attachable to a vehicle receiver hitch a further object to provide such a carrier that is releasably attachable to a vehicle receiver hitch.

a further object to provide such a carrier that deters theft.

a further object to provide a carrier that is easy to use, compact, and capable of carrying bicycles of all shapes and sizes.

a further object to provide such a carrier which includes an integrated locking mechanism that does not require a bicycle to be modified or disassembled to be locked into place.

a further object to provide such a carrier that provides a means for storing the locking mechanism when not in use.

a still further object to provide such a carrier that is of new and novel design, of rugged and durable nature, of simple and economic manufacture and one that is otherwise well-suited to the uses and purposes for which it is intended.

Other and further objects of my invention will appear from the following specification and accompanying drawings which form a part hereof. In carrying out the objects of my invention, it is to be understood that its structures and features are susceptible to change in design and arrangement with only one preferred and practical embodiment of the best known mode being illustrated in the accompanying drawings and specified as is required.

### BRIEF DESCRIPTIONS OF THE DRAWINGS

Specific forms, configurations, embodiments and/or diagrams relating to and helping to describe preferred versions of my invention are explained and characterized herein, often with reference to the accompanying drawings. The drawings and all features shown therein also serve as part of the disclosure of my invention of the current application whether described in the text or by graphical disclosure. Such drawings are briefly described below.

FIG. 1 is an orthographic first side view of my vehicle receiver hitch supported lockable sporting equipment carrier with the locking bar removed from the axial channel of the load beam but aligned therewith to show engagement.

FIG. 2 is an enlarged partial cutaway isometric first side, top and back view of the load beam and vertical beam of my vehicle receiver hitch supported lockable sporting equipment carrier showing three equipment supports carried on the load beam and the locking bar engaged with the load beam and with the vertical beam.

FIG. 3 is an enlarged orthographic back, forward looking view of the sporting equipment carrier of FIG. 1.

FIG. 4 is an orthographic top, downward looking view of the sporting equipment carrier of FIG. 1.

FIG. 5 is an orthographic bottom, upward looking view of the sporting equipment carrier of FIG. 1.

FIG. 6 is an enlarged orthographic side view of the equipment support of FIG. 1 removed from the load beam.

FIG. 7 is an orthographic cross-section view of the vertical beam.

FIG. 8 is an enlarged orthographic cross-section view of the load beam.

### DESCRIPTION OF PREFERRED EMBODIMENT

### Introductory Notes

The readers of this document should understand that the embodiments described herein may rely on terminology used in any section of this document and other terms readily apparent from the drawings and figures and the language common therefore as may be known in a particular art and such as known or indicated and provided by dictionaries. Dictionaries were used in the preparation of this document. Widely known and used in the preparation hereof are Webster's Third New International Dictionary (©1993), The Oxford English Dictionary (Second Edition, ©1989), The New Century Dictionary (©2001-2005) and the American Heritage Dictionary of the English Language (4th Edition ©2000) all of which are hereby incorporated by reference for interpretation of terms used herein, and for application and use of words defined in such references to more adequately or aptly describe various features, aspects and concepts shown or otherwise described herein.

This document is premised upon using one or more terms or features shown in one embodiment that may also apply to or be combined with other embodiments for similar structures, functions, features and aspects of the invention and provide additional embodiments of the invention. Wording used in the claims is also descriptive of the invention and the text of both Claims and Abstract are incorporated by reference into the description entirely. Terminology used with one, some or all embodiments may be used for describing and defining the technology and exclusive rights associated herewith.

### OVERVIEW OF THE APPARATUS

As used herein, the term “forward”, its derivatives, and grammatical equivalents refers to that portion of my sporting equipment carrier that is positioned proximate an operator cab of a vehicle having a receiver hitch for supporting the carrier. The term “rearward”, its derivatives, and grammatical equivalents refers to that portion of my sporting equipment carrier that is positioned distal from the operator cab. The term “outer”, its derivatives, and grammatical equivalents refers to a driver-side portion or passenger-side portion of a vehicle as opposed to the laterally medial portion of a vehicle carrying the sporting equipment carrier.

My improved vehicle receiver hitch supported lockable sporting equipment carrier 9 generally provides a receiver hitch beam 10, a vertical beam 20, a load beam 30 releasably carrying at least one equipment support 50, and a locking bar 40 that releasably engages with the vertical beam 20 and load beam 30.

The receiver hitch beam 10 is elongate and preferably oval shaped in cross section (FIG. 7) and has a first end portion 11 and an upwardly curved second end portion 12. A hitch insert 29 is structurally carried by and axially aligned with the first end portion 11. A locking pin hole 13 is defined in the hitch insert 29 for releasable engagement of a locking pin (not shown) to extend therethrough and secure the hitch insert 29 and the receiver hitch beam 10 to a receiver hitch (not shown) of a carrying vehicle (not shown).

The vertical beam 20 preferably has a peripheral configuration similar to that of the receiver hitch beam 10, but may also include other forms such as round, square, rectangular and other shapes that are strong as well as aesthetically appealing. The vertical beam 20 has a first lower end portion 21 and an opposing second upper end portion 22 with a medial channel (not shown) extending from the first end portion 21 to the second end portion 22. The first lower end 21 of the vertical beam 20 is structurally interconnected with the upwardly curved second end 12 of the receiver hitch beam 10 such as by welding so that the vertical beam 20 extends generally perpendicularly relative to the receiver hitch beam 10. It is contemplated however that the receiver hitch beam 10 and the vertical beam 20 may also be cast or molded, or otherwise formed as a unitary piece without the need for a seam or joint to interconnect the adjacent end portions thereof.

Gusset 15 structurally communicates between the receiver hitch beam 10 and the vertical beam 20 to provide additional structural integrity and load bearing capability.

Load beam hole 24 is defined in the vertical beam 20 spacedly adjacent the second upper end 22, forming a channel (not shown) extending through the vertical beam 20 from a front side 20a to a rear side 20b. A locking bar hole 25 is defined in the vertical beam 20 spacedly adjacent above the support beam hole 24 more proximate the second upper end 22. Similar to the support beam hole 24, the locking bar hole 25 defines a channel (not shown) extending through the vertical beam 20 from a front side 20a to a rear side 20b. Bushing 26 is carried in the channel (not shown) defined by the locking bar hole 25 to provide secure engagement with the locking bar 40 and to reduce metal on metal contact that might cause excessive wear and noise. End cap 27 is carried at the second end 22 of the vertical beam 20 to prevent water, debris and the like from entering the channel (not shown), and also to provide a more aesthetically appealing appearance.

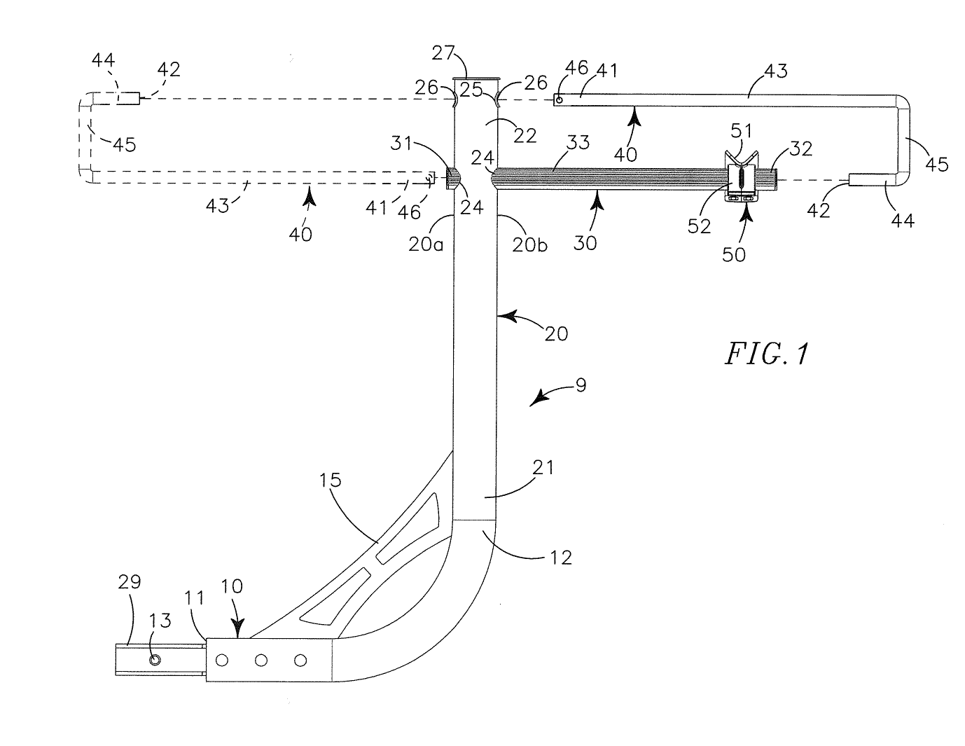

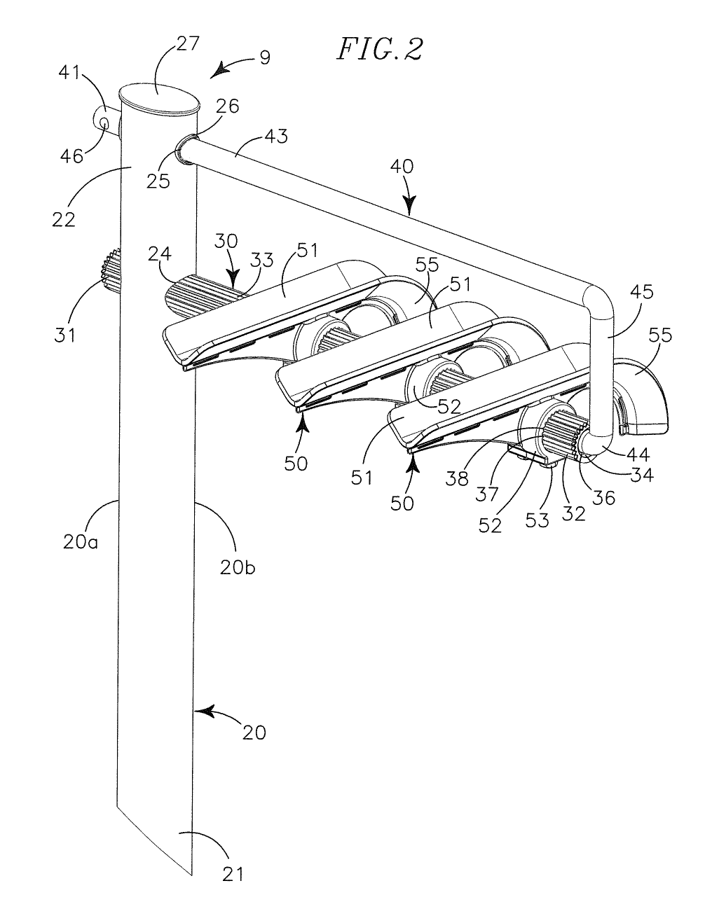

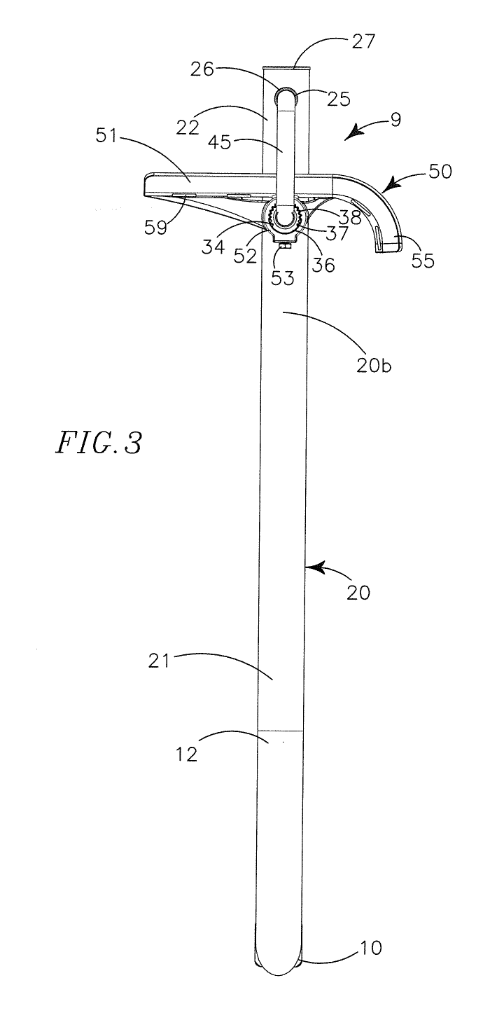

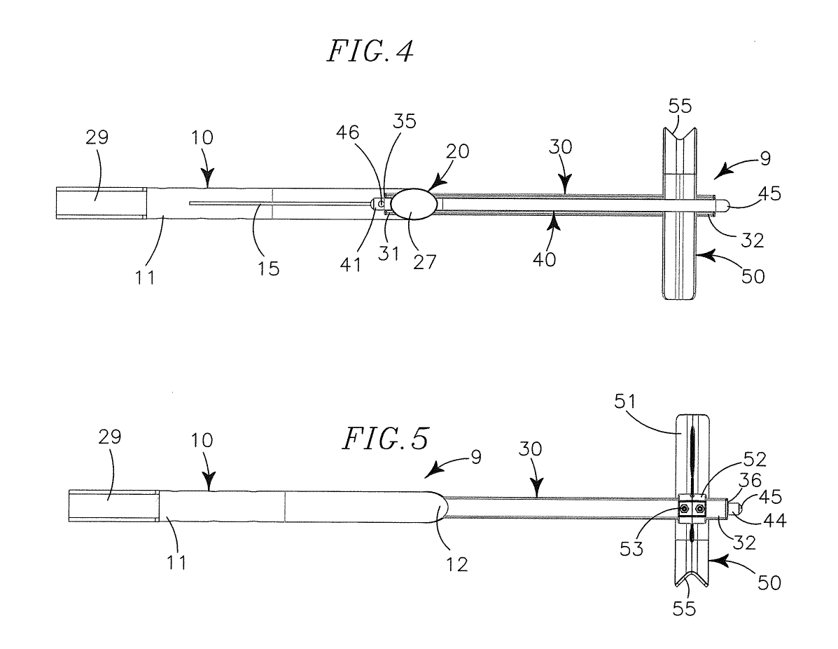

The load beam 30 is elongate and extends generally perpendicularly rearwardly from the vertical beam 20. The load beam 30 has a first end portion 31 and an opposing second end portion 32 and defines in axial channel 34 communicating between the first end portion 31 and the second end portion 32. The load beam 30 is structurally interconnected with the vertical beam 20 and extends through the channel (not shown) defined by the support beam hole 24 and is structurally secured in place, such as by welding about all immediately adjacent surfaces on both the front side 20a and the rear side 20b of the vertical beam 20. The load beam 30 extends parallel to the receiver hitch beam 10 in a direction opposite the receiver hitch beam 10 such that the carrier 9, when viewed from a orthographic side view (FIG. 1) has a squared “Z” shape.

The axial channel 34 defined by the load beam 30 has a first orifice 35 defining an opening to the axial channel 34 on the front side 20a of the vertical beam 20, and a second orifice 36 defining an opening to the axial channel 34 at the second end portion 32 of the load beam 30 on the rear side 20b of the vertical beam 20. In the preferred embodiment, the load beam 30 is formed of stainless steel because of stainless steel's strength, resistance to cutting, durability and resistance to rust, corrosion and the like. It is anticipated however that other materials such as, but not limited to aluminum, aluminum alloys, steel, steel alloys and composites may likewise be used for the load beam 30. Further the load beam 30 is “fluted” on at least a portion of its outer circumferential surface 33 defining plural spacedly arrayed axially aligned grooves 37 and ridges 38 for securely carrying the at least one equipment support 50. In the preferred embodiment, the grooves 37 and ridges 38 extend only partially about the outer circumferential surface 33 of the load beam 30 (FIG. 8) but it is expressly contemplated the grooves 37 and ridges 38 may also extend completely about the load beam 30.

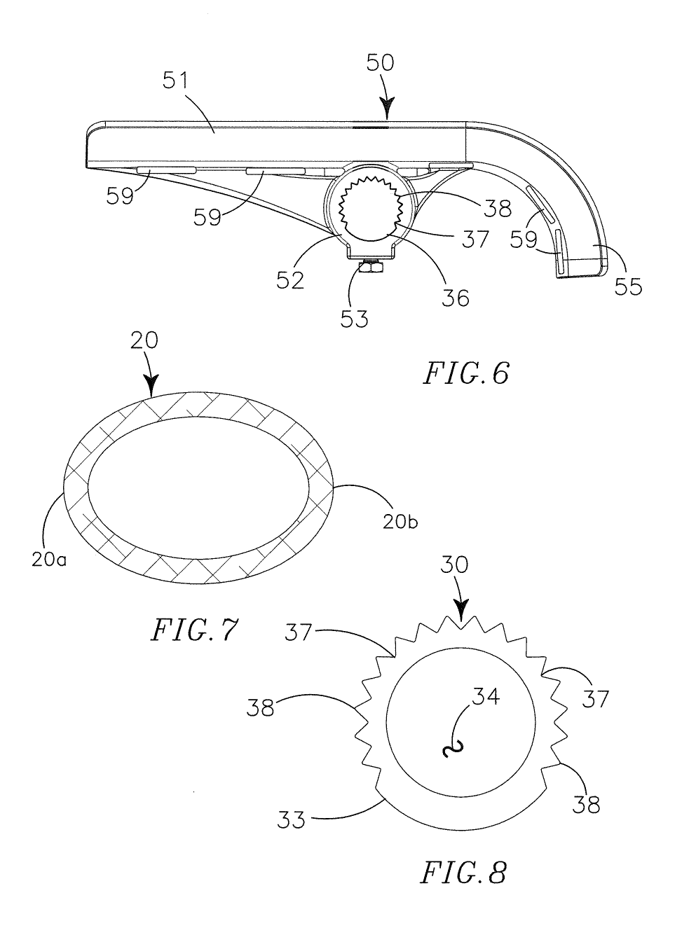

The equipment support 50 (FIG. 6) may have a variety of configurations, but in the preferred embodiment includes an elongated base tray 51 that defines an open top “trough” such that a portion of a bicycle frame (not shown) may be carried within the trough which may be angular or concave or similar thereto in configuration. A load beam sleeve 52 is structurally interconnected to a bottom portion of the base tray 51 and provides a means for attaching the equipment support 50 to the load beam 30. In the preferred embodiment, an inner circumferential surface of the load beam sleeve 52 defines plural spacedly axially aligned arrayed grooves 57 and ridges 58 configured to axially slidably “mate” with the plural spacedly arrayed grooves 37 and ridges 38 defined in the outer circumferential surface 33 of the load beam 30 so that the load beam 30 may pass axially through a medial channel 56 defined by the load beam sleeve 52. In the preferred embodiment there are a greater number of axially aligned grooves 57 and ridges 58 defined in the load beam sleeve 52 than there are axially aligned grooves 37 and ridges 38 defined in the load beam 30 to allow the equipment support 50 to be axially rotated relative to the load beam 30 to provide some angular adjustment therebetween to accommodate different styles, types and configurations of bicycle frames (not shown) so that the bicycle (not shown) maybe carried on the equipment support 50 in a generally horizontal orientation which is desirable to reduce the possibility of one of the bicycle wheels (not shown) contacting the ground while the carrying vehicle is moving resulting in possibly catastrophic damage to the bicycle (not shown), the carrier 9, the carrying vehicle (not shown) and possibly to other motorists/pedestrians.

Known securing means 53, such as, but not limited to, threaded bolts may be carried in radially aligned threaded holes (not shown) defined in the load beam sleeve 52 to frictionally engage with the outer circumferential surface 33 of the load beam 30 to positionally secure the equipment support 50 onto the load beam 30 and to prevent undesirable movement of the equipment support 50 relative to the load beam 30.

Known releasable adjustable securing straps (not shown), such as elongate pieces of “hook and loop” fastener, “bungee cords” and the like are fastened to the equipment support 50 and may pass through slots 59 defined in the equipment support 50 below the base tray 51 to positionally secure the bicycle (not shown) to the equipment support 50. In a particularly preferred embodiment, each base tray 51 of each equipment support 50 includes an angularly depending leg 55 at one end portion of the base tray 51. The angular leg 55 is configured to frictionally communicate with a vertical element of the bicycle frame (not shown) and be secured thereto with a securing strap (not shown) so that the bicycle (not shown) does not slidably move within the base tray 51 and does not axially rotate within the base tray 51 responsive to movement and vibration of the vehicle during use of the vehicle.

The locking bar 40 has a somewhat horizontal “J” configuration having a longer first leg 43, a shorter second leg 44 and an offsetting leg 45 joining the first leg 43 and the second leg 44 at proximate end portions thereof so that the second leg 44 extends parallel to the first leg 43 and in the same direction. The offsetting leg 45 need not be orthogonal but may also be curvilinear. The first leg 43, the offsetting leg 45 and the second leg 44 are structurally interconnected at adjacent end portions, such as by welding. In an alternative embodiment, the locking bar 40 may be bent, or otherwise formed from a unitary piece of material to form the first leg 43, the offsetting leg 45 and the second leg 44. A lock hasp hole 46 is defined in the first leg 43 proximate first end portion 41 opposite the offsetting leg 45 to provide for releasable engagement with a lock (not shown).

As shown in Figures, engagement of the locking bar 40 with the load beam 30 and the vertical beam 20 creates “cage” about the equipment support 50 and any bicycles (not shown) carried thereon. The first end portion 41 of the first leg 43, opposite the offsetting leg 45 passes through the locking bar hole 25 defined in the vertical beam 20 and the bushing 26 carried therein, while simultaneously, the second end portion 42 of the second leg 44, opposite the offsetting leg 45 passes into the second orifice 36 and engages with the axial channel 34 defined in the load beam 30. After the first and second legs 43, 44 respectively of the locking bar 40 are engaged with the locking bar hole 25 and the axial channel 34 of the load beam 30 and the first end portion 41 of the first leg 43 has passed completely through the locking bar hole 25 defined in the vertical beam 20 and extends outwardly from the first side 20a of the vertical beam 20, a known lock (not shown) preferably a “shoulder-type lock” having an approximately ¾″ opening between its shoulder portions, a commercially available example of which is identified as a TMC 10FL TRIMAX Deluxe Key Coupler Lock manufactured by TRIMAX™ Corporation of Englewood Colo., USA (similar “shoulder-type locks” are available from other lock manufacturers as well) is engaged with lock hasp hole 46 defined in the first leg 43 of the locking bar 40 on a front side 20a of the vertical beam 20. Engagement of the lock (not shown) with the lock hasp hole 46 prevents the locking bar 40 from being axially withdrawn from the locking bar hole 25.

The inability to axially withdraw the locking bar 40 from the locking bar hole 25 defined in the vertical beam 20 maintains engagement of the second leg 44 with the axial channel 34 defined in the load beam 30. The inability to remove, or otherwise axially twist the locking bar 40 maintains the “cage” surrounding and engaging the bicycle (not shown) carried on the carrier 9. Only by removing the lock (not shown) engaged with the lock hasp hole 46 may the locking bar 40 be withdrawn, and the bicycles (not shown) be removed from the equipment carrier 50.

The identified shoulder-type coupler lock is preferred because it has a structural configuration that tightly engages with the locking bar 40 and lock hasp hole 46, and does not allow easy access to the lock hasp by a bolt cutter, or other device that might be used to cut the lock from the carrier. Other coupler locks may likewise be used, but I have found the aforementioned TRIMAX shoulder-type coupler lock to be preferred.

As shown in FIG. 1 (in dashed outline), the locking bar 40 may also be stored within the axial channel 34 of the load beam 30 by inserting the first end portion 41 of the first leg 43 of the locking bar 40, into the first opening orifice 35 of the axial channel 34 from a front side 20a of the vertical beam 20, opposite the load beam 30, and simultaneously passing the second end portion 42 of the second leg 44 into and through the locking bar hole 25 on the front side 20a of the vertical beam 20 and thereafter securing a lock (not shown) in the lock hasp hole 46 defined in the first leg 43. Such secure storage of the locking bar 40 will prevent theft of the locking bar 40 and also prevents any rattling and otherwise disturbing noises that may be generated by the locking bar 40 when bicycles (not shown) are not stored on the carrier 9 and the vehicle (not shown) is operated.

### Construction and Materials of the Apparatus

The receiver hitch beam 10 and the vertical beam 20 are preferably formed of aluminum tubing that has been “squeezed” into an oval cross-sectional shape (FIG. 7) or other strong rigid material such as, but not limited to steel, steel alloys, stainless steel, aluminum alloys, composites, and the like. Although the receiver hitch insert 29 is necessarily of a box beam configuration to engage with the receiver hitch 61, the vertical beam 20 need not have a box beam configuration and it is anticipated that other configurations, such as round and other orthogonal shapes may also be employed.

The locking bar 40 is preferably formed from hardened steel, stainless steel or other metal alloys that are difficult to cut. Preferably the locking bar 40 is formed from solid bar stock.

The load beam 30 is preferably formed of stainless steel because of the material's strength, durability, hardness, resistance to cutting and bending and resistance to corrosion such as rust and the like. Aluminum, aluminum alloys, steel, steel alloys and composites are also contemplated.

Having described the structure of my improved vehicle receiver hitch supported lockable sporting equipment carrier, its operation may be understood.

The carrier 9 is oriented so that the hitch insert 29 may be axially inserted into a channel (not shown) defined by a receiver hitch (not shown) carried by a vehicle (not shown). The hitch insert 29 is thereupon axially inserted into the receiver hitch channel (not shown). The locking pin hole 13 is aligned with locking pin holes (not shown) defined in the receiver hitch (not shown) and a locking pin (not shown) is inserted therethrough to positionally secure the carrier 9 relative to the receiver hitch (not shown) and vehicle (not shown). If desired, the locking pin (not shown) may be lockable to prevent unauthorized removal.

The locking bar 40 is removed from engagement with the locking bar hole 25 defined in the vertical beam 20 and from the axial channel 34 defined by the load beam 30 by axially withdrawing the locking bar 40, relative to the load beam 30.

At least one equipment support 50 is positioned on the load beam 30, by passing the load beam sleeve 52 of the equipment support 50 over and about the load beam 30. The angle of the equipment support 50 relative to the load beam 30 is adjusted by aligning the mating grooves 37 and ridges 38 defined in the load beam 30 with the mating grooves 57 and ridges 58 defined in the inner circumferential surface of the load beam sleeve 52 and then sliding the equipment holder 50 and load beam sleeve 52 axially onto the load beam 30 with the load beam 30 passing axially through the load beam sleeve 52. Friction fittings 53 are tightened to positionally secure the equipment support 50 to the load beam 30. The orientation of the equipment support 50 may be adjusted as necessary depending upon the configuration of the bicycle frame 63. Once the orientation of the base tray 51 has been determined, the friction fittings 53 should be securely tightened so that the equipment support 50 does not move relative to the load beam 30.

The securing straps 54 are loosened and a bicycle is placed within the base tray 51 so that the bicycle frame (not shown) rests within the trough and the bicycle depends therefrom. The bicycle frame (not shown) should be moved elongately relative to the base tray 51 so that the angular leg 55 of the equipment support 50 frictionally communicates with a vertically extending portion of the bicycle frame (not shown), such as a bicycle seat support. The securing straps 54 are thereafter passed through the through slots 59 defined in the equipment support 50 and secured about the bicycle frame (not shown) to positionally maintain the bicycle frame (not shown) within the base tray 51 and frictionally against the angular leg 55 to prevent any movement or rotation of the bicycle frame (not shown) relative to the equipment support 50.

If more than one bicycle (not shown) is to be fastened to the carrier 9, the process, as noted above, is repeated for the second and any subsequent bicycle.

The locking bar 40 is installed by orienting the locking bar 40 such that the first leg 43 is horizontal relative to the ground and the first leg is positioned vertically above the second leg 44, and the offsetting leg 45 is distal from the vertical beam 20. The first end portion 41 of the first leg 43 is inserted into the locking bar hole 25. Once the first end portion 41 of the first leg 43 has entered into the locking bar hole 25 the locking bar 40 may be rotated axially about the first leg 43 to align the second leg 44 with the second orifice 36 to the axial channel 34 defined by the load beam 30. Once the second end portion 42 of the second leg 44 is axially aligned with the second orifice 36 to the axial channel 34, the locking bar 40 is moved axially toward the vertical beam 20 so that the second leg 44 of the locking beam 40 enters into and engages with the axial channel 34 defined by the load beam 30. A lock (not shown) is thereafter engaged with the lock hasp hole 46 defined in the first end portion 41 of the first leg 43 of the locking bar 40, on the front side 20a of the vertical beam 20 opposite the load beam 30 and the bicycles.

When the bicycles are to be removed from the carrier 9, the lock (not shown) engaged with the lock hasp hole 46 defined in the first end portion 41 of the first leg 43 is disengaged, such as with a key, and removed from the lock hasp hole 46. Thereafter, the locking bar 40 may be axially withdrawn from the locking bar hole 25 such that the locking bar 40 is disengaged from the carrier 9, and the bicycles may be removed.

To store the locking bar 40, such as when the carrier 9 is not in use, the locking bar 40 is oriented such that the first leg 43 and the second leg 44 are horizontal relative to the ground with the second leg 44 vertically above the first leg 43. The first end portion 41 of the first leg 43 is aligned with the first orifice 35 of the axial channel 34 on a front side 20a of the vertical beam 20, and is inserted therein. The second end portion 42 of the second leg 44 is aligned with the locking bar hole 25 on a front side 20a of the vertical beam 20, and the second leg is thereafter passed into and through the locking bar hole 25 so that the second end portion 42 of the second leg 44 passes through the vertical beam 20 and extends outwardly from a rear side 20b of the vertical beam 20 proximate the load beam 30. Thereafter, a lock (not shown) is engaged with the lock hasp hole 46 which secures the locking bar 40 in place and prevents theft or loss thereof.

### Interpretation Notes

The above description has set out various features, functions, methods and other aspects of my invention. This has been done with regard to the currently preferred embodiments thereof. Time and further development may change the manner in which the various aspects are implemented. Such aspects may further be added to by the language of the claims which are incorporated by reference. The scope of protection accorded my invention, as defined by the claims, is not intended to be necessarily limited to the specific sizes, shapes, features or other aspects of the currently preferred embodiment shown and described. The claimed invention may be implemented or embodied in other forms still being within the concepts shown, described and claimed herein. Also included are equivalents of the invention which can be made without departing from the scope or concepts properly protected hereby.

The foregoing description of my invention is necessarily of a detailed nature so that a specific embodiment of a best mode may be set forth as is required, but it is to be understood that various modifications of details, sizes, and rearrangement, substitution and multiplication of the parts may be resorted to without departing from its spirit, essence or scope.

Having thusly described my invention, I hereby file this Utility patent application and pray for issuance of Utility Letters patent.

1. An improved vehicle receiver hitch mounted sporting equipment carrier having a generally horizontally extending load beam for carrying sporting equipment, the improvement comprising in combination:
at least one axially aligned flute defined in an outer circumferential surface of the generally horizontally extending load beam; and
an equipment support releasably adjustable carried on the generally horizontally extending load beam, the equipment support defining a load beam sleeve defining a mating flute on an inner circumferential surface to engage with the flute defined in the generally horizontally extending load beam to prevent the equipment support from rotating axially relative to the generally horizontally extending load beam.

2. The improved sporting equipment carrier of claim 1 wherein:
plural spacedly arrayed axially aligned flutes are defined in the generally horizontally extending load beam.

3. The improved sporting equipment carrier of claim 2 wherein:
plural spacedly arrayed axially aligned mating flutes are defined in the load beam sleeve carried by the equipment support.

4. The improved sporting equipment carrier of claim 1 wherein:
the at least one flute defines an axially aligned groove and has an axially aligned ridge.
